(19) United States
(12) Patent Application Publication
(10) Pub. No.: US 2018/0083361 A1
(43) Pub. Date: Mar. 22, 2018

(54) ANTENNA DEVICE

(71) Applicants: YOKOWO CO., LTD., Tokyo (JP); HONDA MOTOR CO., LTD., Tokyo (JP)

(72) Inventors: Takeshi SANPO, Tomioka-shi (JP); Mutsumi KATAYAMA, Saitama (JP); Yasuhiro KONNO, Saitama (JP)

(21) Appl. No.: 15/709,757

(22) Filed: Sep. 20, 2017

(30) Foreign Application Priority Data
Sep. 22, 2016 (JP) 2016-184959

(51) Int. Cl. H01Q 9/28; H01Q 9/30; H01Q 1/24

(52) U.S. Cl. CPC H01Q 9/28; H01Q 1/241; H01Q 9/30

(57) ABSTRACT

An antenna device includes a first plate-shaped metal plate and a second plate-shaped metal plate configuring a bow-tie antenna. The first plate-shaped metal plate and the second plate-shaped metal plate extend upwardly and downwardly from a feeding point, respectively. The feeding point is located at a position offset in a positive x direction from an x-direction center position of the first plate-shaped metal plate. A magnetic core is mounted on a feeder line that is a coaxial cable. The magnetic core is accommodated between a negative x-direction side end portion of the first plate-shaped metal plate and the feeding point, in the x direction.

### BACKGROUND OF THE INVENTION

### Field of the Invention

The present invention relates to an antenna device including a bow-tie antenna.

### Description of the Related Art

FIG. 2 is a schematic configuration diagram of a typical bow-tie antenna. The bow-tie antenna shown in FIG. 2 includes antenna elements 110, 120 respectively extending in upper and lower directions from a feeding point 5. Each of the antenna elements 110, 120 is an isosceles-triangular metal plate having the feeding point 5 at the apex. The feeding point 5 is located on an imaginary line Lc connecting the middle points of the bases of the antenna elements 110, 120. A feeder line 31 is connected to the feeding point 5. The bow-tie antenna can cover a wide frequency band of LTE (Long Term Evolution) etc.

### PATENT LITERATURE 1

Japanese Laid-Open Patent Publication No. 2011-193432

In general, a coaxial cable is used for a feeder line transmitting a high frequency from the viewpoint of suppression of influence of external electromagnetic waves, reduction in loss due a leakage power, etc. While the coaxial cable is an unbalanced feeder line, the bow-tie antenna is a balanced antenna and, therefore, when the coaxial cable is used as the feeder line 31 of the bow-tie antenna (when the bow-tie antenna and the coaxial cable are connected), a problem occurs that a leakage current flows through an outer conductor of the coaxial cable. Therefore, as shown in FIG. 3, by mounting a cylindrical magnetic core 71 (e.g., a ferrite core) on the coaxial cable, the leakage current can be suppressed over a wide band.

However, in the configuration of FIG. 3, the magnetic core 71 protrudes from the configuration range of the bow-tie antenna. Specifically, the magnetic core 71 significantly extends outward beyond an imaginary line Le extending vertically and passing through the left end of at least one of the antenna elements 110, 120 in FIG. 3. Therefore, in the configuration of FIG. 3, a case not shown holding the antenna elements 110, 120 and the magnetic core 71 must be made larger in accordance with an amount of protrusion of the magnetic core 71, causing a problem of an increased size at the time of productization as an antenna device.

### SUMMARY OF THE INVENTION

The present invention was conceived based on recognition of these problems and it is therefore an object of the present invention to provide an antenna device capable of restraining an increase in size while suppressing a leakage current in a configuration including a bow-tie antenna.

A first aspect of the present invention is a antenna device. The antenna device comprising:

a bow-tie antenna;

a first coaxial cable connected to the bow-tie antenna; and

a first magnetic core penetrated by the first coaxial cable, wherein

when three respective orthogonal axes are an x axis, a y axis, and a z axis,

the bow-tie antenna includes a first plate-shaped metal having a portion extending from a feeding point in the +z direction in substantially parallel to the xz plane and a second plate-shaped metal having a portion extending from the feeding point in the −z direction in substantially parallel to the xz plane, wherein

the first magnetic core is located on the −x-direction side of the feeding point and within an existence range of the first and second plate-shaped metals in the z direction and has a position in the x direction overlapping with the first and second plate-shaped metals, and the feeding point is located at a position offset in the +x direction from an x-direction center position of the first plate-shaped metal or an x-direction center position of the second plate-shaped metal.

The first magnetic core may be accommodated between a −x-direction side end portion of the first or second plate-shaped metal and the feeding point in the x direction.

The axial direction of the first magnetic core may be substantially parallel to the x direction

A second aspect of the present invention is a antenna device. The antenna device comprising:

a bow-tie antenna;

a first coaxial cable connected to the bow-tie antenna; and

a first magnetic core penetrated by the first coaxial cable, wherein

the bow-tie antenna has a substantially triangular first plate-shaped metal and a substantially semicircular second plate-shaped metal, and wherein

for a feeding point serving as a mutual contact point between the first and second plate-shaped metals, a distance to an apex of the first plate-shaped metal on the side disposed with the first magnetic core is longer than a distance to an apex on the opposite side.

A third aspect of the present invention is a antenna device. The antenna device comprising:

a bow-tie antenna;

a first coaxial cable connected to the bow-tie antenna,

a second coaxial cable connected to an antenna different from the bow-tie antenna,

a first magnetic core penetrated by the first coaxial cable; and

a second magnetic core penetrated by the second coaxial cable, wherein

when three respective orthogonal axes are an x axis, a y axis, and a z axis,

the bow-tie antenna includes a first plate-shaped metal having a portion extending from a feeding point in the +z direction in substantially parallel to the xz plane and a second plate-shaped metal having a portion extending from the feeding point in the −z direction in substantially parallel to the xz plane, wherein

the second plate-shaped metal has a convex curved portion having a shorter dimension in the z-direction than the first plate-shaped metal and curved to approach parallel to the z direction as the portion extends in the −x direction from the feeding point that is a contact point with the first plate-shaped metal, and

one of the first and second magnetic cores is disposed on the second plate-shaped metal side in the z direction.

The antenna device further may comprise an antenna different from the bow-tie antenna,

second and third coaxial cables connected to the different antenna, and

second and third magnetic cores respectively penetrated by the second and third coaxial cables, wherein

the first to third magnetic cores are stacked in trefoil formation.

Any arbitrary combination of the above-described constituent elements and the descriptions of the present invention which are converted between methods and systems are all effective as aspects of the present invention.

The present invention enables provision of the antenna device capable of restraining an increase in size while suppressing a leakage current in a configuration including a bow-tie antenna.

### BRIEF DESCRIPTION OF THE DRAWINGS

FIG. 1 is a schematic configuration diagram of an antenna device 1 according to a first embodiment of the present invention;

FIG. 2 is a schematic configuration diagram of a typical bow-tie antenna;

FIG. 3 is a schematic configuration diagram when a magnetic core 71 is mounted on a feeder line 31 in the configuration of FIG. 2;

FIG. 4 is a schematic perspective view of an antenna device 2 according to a second embodiment of the present invention;

FIG. 5 is a perspective view of an antenna device 3 according to a third embodiment of the present invention with a cover 80 removed;

FIG. 6 is a right side view of the same;

FIG. 7 is a right side view of the antenna device 3 with the cover 80 attached; and

FIG. 8 is an exploded perspective view of the antenna device 3.

### DESCRIPTION OF THE PREFERRED EMBODIMENTS

Now, preferred embodiments of the present invention will be described in detail, referring to the drawings. The same or equivalent constituent elements, members and so on which are shown in the respective drawings are denoted with the same reference numerals, and overlapped descriptions are appropriately omitted. Moreover, the present invention is not limited to the embodiments, but the embodiments are only examples. All features and the combinations of the features which are described in the embodiments are not absolutely essential to the present invention.

### First Embodiment

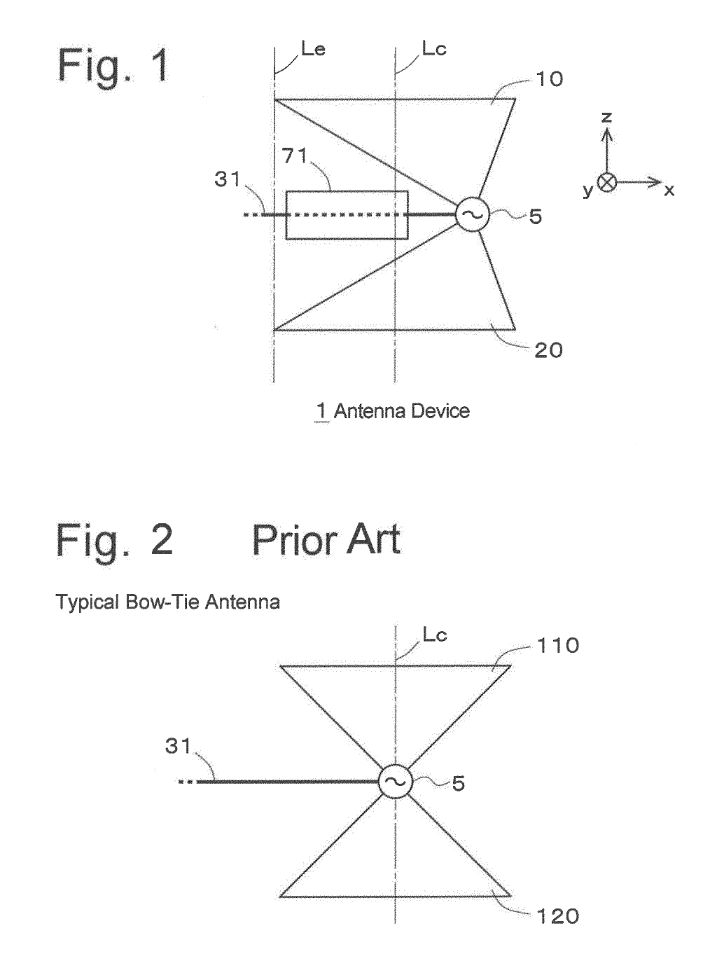

FIG. 1 is a schematic configuration diagram of an antenna device 1 according to a first embodiment of the present invention. In FIG. 1, x-, y-, and z-axes are defined as three orthogonal axes. The antenna device 1 includes a first plate-shaped metal 10 and a second plate-shaped metal 20 constituting a bow-tie antenna. The first plate-shaped metal 10 has a triangular shape extending in the +z direction from a feeding point 5 in substantially parallel to the xz plane and having the feeding point 5 at the apex. The second plate-shaped metal 20 has a triangular shape extending in the −z direction from the feeding point 5 in substantially parallel to the xz plane and having the feeding point 5 at the apex. To the feeding point 5, a feeder line 31 is connected as a first coaxial cable. On the feeder line 31, a tubular (e.g., cylindrical) magnetic core 71 (e.g., ferrite core) is mounted for reducing a leakage current. Therefore, the feeder line 31 penetrates the magnetic core 71. The axial direction of the magnetic core 71 is substantially parallel to the x direction. The magnetic core 71 is located on the −x direction side of the feeding point 5 and within the existence range of the first plate-shaped metal 10 and the second plate-shaped metal 20 in the z direction.

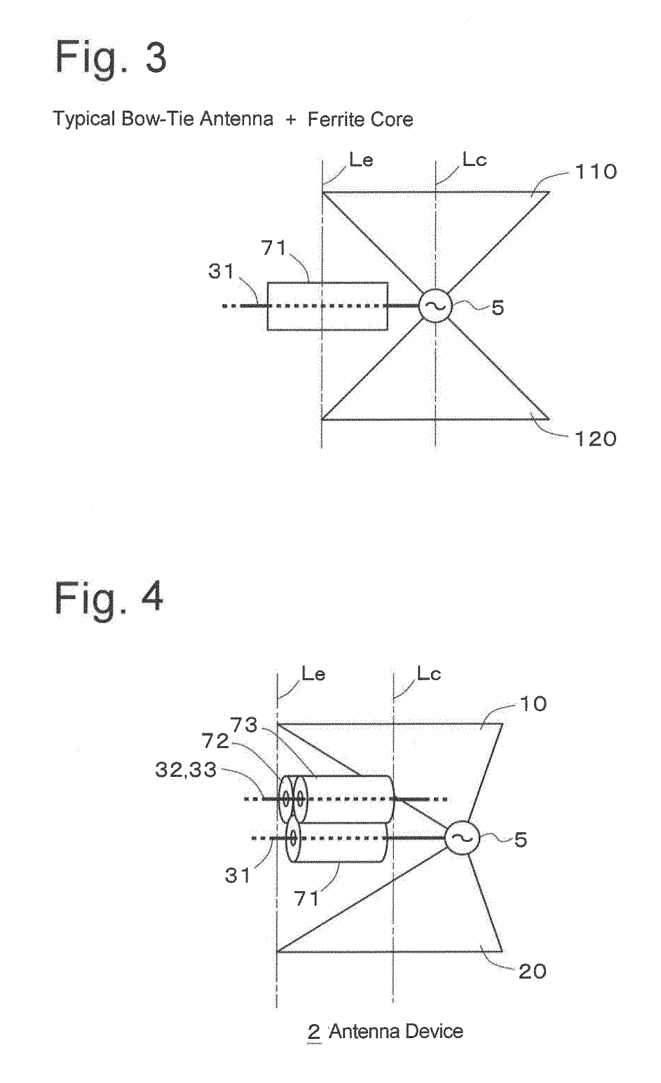

In this embodiment, unlike the bow-tie antenna shown in FIG. 2, the feeding point 5 is located at a position offset in the +x direction from at least one of the x-direction center position of the first plate-shaped metal 10 and the x-direction center position of the second plate-shaped metal 20. Therefore, the feeding point 5 is shifted by a predetermined distance in the +x direction with respect to an imaginary line Lc parallel to the z direction passing through the middle point of the side of the first plate-shaped metal 10 or the second plate-shaped metal 20 facing the feeding point 5. Thus, in this embodiment, as compared to the bow-tie antenna shown in FIG. 2, a larger distance is formed between the feeding point 5 and an imaginary line Le parallel to the z direction passing through the −x-direction side end portion of at least one of the first plate-shaped metal 10 and the second plate-shaped metal 20. Therefore, in this embodiment, unlike the case of FIG. 3, the magnetic core 71 does not protrude from the imaginary line Le toward the −x direction. In other words, the magnetic core 71 is accommodated between the −x-direction side end portion of the first plate-shaped metal 10 or the second plate-shaped metal 20 and the feeding point 5 in the x direction. Therefore, according to this embodiment, as compared to the configuration shown in FIG. 3, a case not shown holding the first plate-shaped metal 10, the second plate-shaped metal 20, and the magnetic core 71 can be reduced in size, so as to restrain an increase in product size while suppressing a leakage current. If the offset amount of the feeding point 5 in the +x direction is small, the magnetic core 71 may still protrude from the imaginary line Le toward the −x-direction; however, as compared to the configuration shown in FIG. 3, the protrusion amount is reduced, so that the effect of restraining an increase in size can be acquired. The shapes of the first plate-shaped metal 10 and the second plate-shaped metal 20 may not be symmetrical to each other.

### Second Embodiment

FIG. 4 is a schematic perspective view of an antenna device 2 according to a second embodiment of the present invention. The antenna device 2 of this embodiment is identical to the antenna device of the first embodiment shown in FIG. 1 except that the bow-tie antenna made up of the first plate-shaped metal 10 and the second plate-shaped metal 20 is combined with other antennas not shown, resulting in three output systems. Feeder lines 32, 33 are provided as second and third coaxial cables for the additional two output systems. On the respective feeder lines 32, 33, tubular (e.g., cylindrical) magnetic cores 72, 73 (e.g., ferrite cores) are mounted for reducing a leakage current (the feeder lines 32, 33 respectively penetrate the magnetic cores 72, 73). The magnetic cores 71 to 73 have the same x-direction positions as each other and the axial direction substantially parallel to the x direction. In this embodiment, a space is saved by arranging the magnetic cores 71 to 73 in trefoil formation (formation of stacked bales). This embodiment can produce the same effects as the first embodiment.

### Third Embodiment

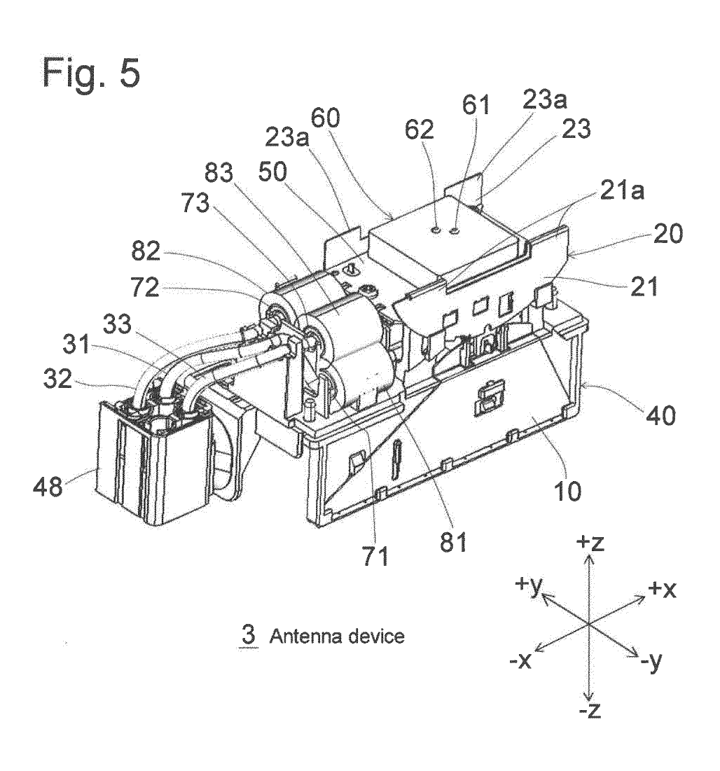

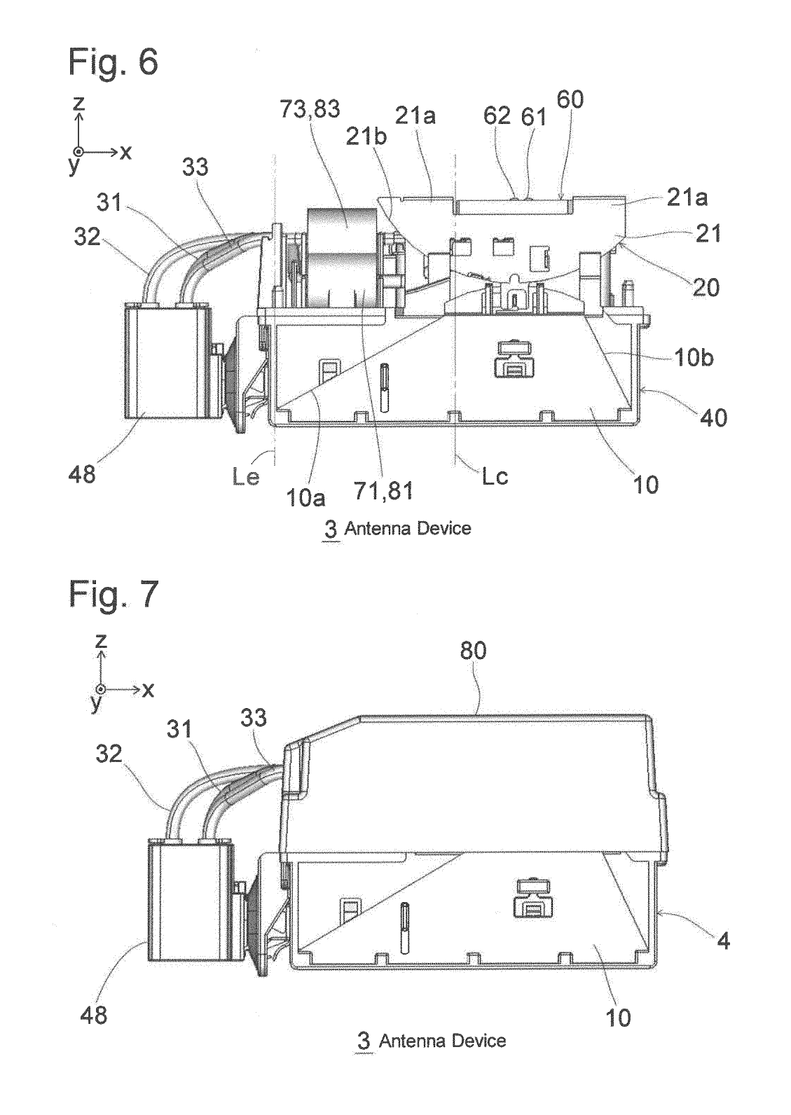

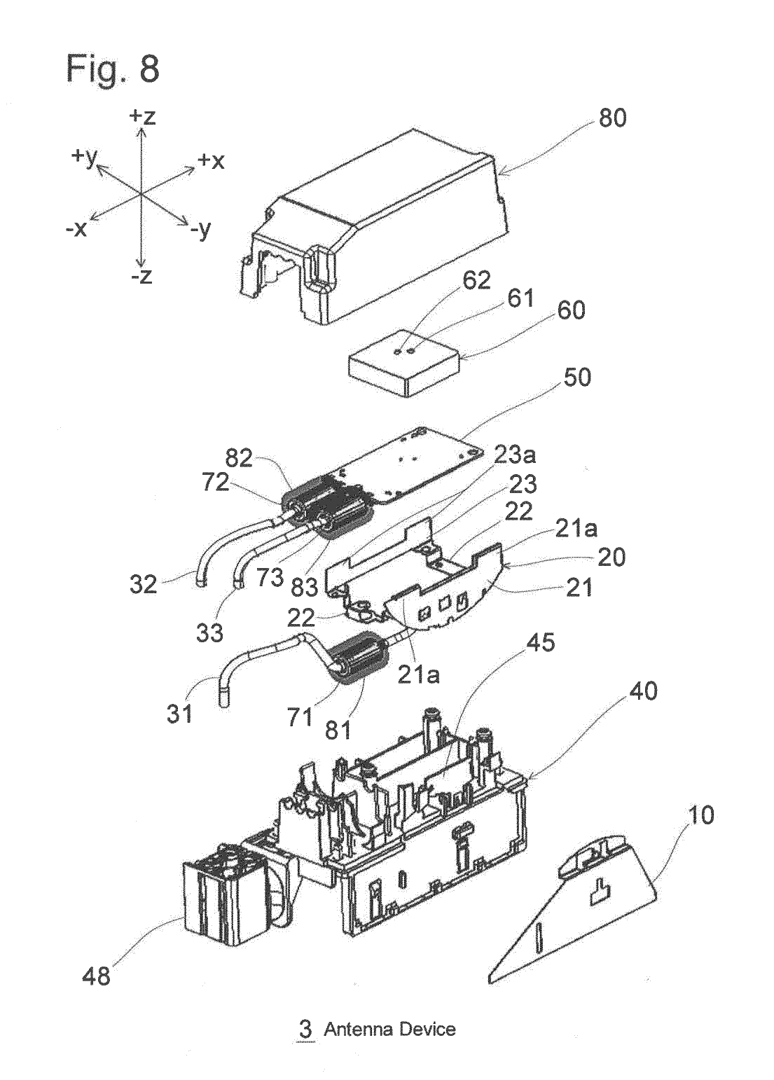

FIG. 5 is a perspective view of an antenna device 3 according to a third embodiment of the present invention with a cover 80 removed. FIG. 6 is a right side view of the same. FIG. 7 is a right side view of the antenna device 3 with the cover 80 attached. FIG. 8 is an exploded perspective view of the antenna device 3. The antenna device 3 is formed by combining, for example, a bow-tie antenna capable of transmitting and receiving a frequency band of a mobile phone and a patch antenna capable of transmitting and receiving frequency bands of GPS (Global Positioning System) and GLONASS (Global Navigation Satellite System), and has three output systems. GPS and GLONASS are included in GNSS (Global Navigation Satellite Systems). It is noted that only either one of GPS and GLONASS may be included.

In the antenna device 3, the first plate-shaped metal 10, the second plate-shaped metal 20, and a TEL antenna substrate 45 constitute the bow-tie antenna. A GNSS antenna substrate 50 and a GNSS antenna element 60 constitute the patch antenna. A base (lower case) 40 is made of an insulating resin, for example, and holds the first plate-shaped metal 10, the second plate-shaped metal 20, the TEL antenna substrate 45, the GNSS antenna substrate 50, and magnetic cores 71 to 73. The cover (upper case) 80 is made of an insulating resin, for example, and attached to the base 40 from above (the +z-direction side) to cover the whole except the second plate-shaped metal 20.

The first plate-shaped metal 10 has a substantially triangular shape and is engaged and held in substantially parallel to the xz plane by claws etc. on a side surface (a side surface parallel to the xz plane facing in the −y direction) of the base 40. A side 10a extending from a feeding point of the first plate-shaped metal 10 on the −x-direction side is longer than a side 10b extending on the +x-direction side. In other words, for the feeding point serving as the mutual contact point between the first plate-shaped metal 10 and the second plate-shaped metal 20, the distance to an apex of the first plate-shaped metal 10 on the −x-direction side (the side disposed with the magnetic cores 71 to 73) is longer than the distance to an apex on the opposite side (the +x-direction side). The second plate-shaped metal 20 is fixed to the upper surface of the base 40 by a screw etc. Specifically, the second plate-shaped metal 20 has respective convex portions 21a protruding in the +Z direction on both x-direction end portions at +z-direction side end portions of a substantially semicircular principal surface portion 21 that is substantially flush with the first plate-shaped metal 10. The second plate-shaped metal 20 is folded at upper end portions of the convex portions 21a toward the −z direction and extended by respective connecting portions 22 toward the +y direction such that a vertically extending portion 23 stands from +y-direction side end portions of the connecting portions 22, and the connecting portions 22 are screwed and fixed to the upper surface of the base 40. In the second plate-shaped metal 20, portions other than the principal surface portion 21 also act as an antenna element. The second plate-shaped metal 20 has a shorter dimension in the z-direction than the first plate-shaped metal 10, and has a convex curved portion 21b (FIG. 6) curved to approach parallel to the z direction (parallel to the imaginary line Le) as the portion extends in the −x direction from the feeding point that is the contact point with the first plate-shaped metal 10. The magnetic core 73 is disposed in a space generated by curving in this way. Convex portions 23a protruding in the +Z direction are respectively disposed on both x-direction end portions at +z-direction side end portions of the vertically extending portion 23. The convex portions 21a and the convex portions 23a are located on both sides of the GNSS antenna element 60 in the x direction so as not to cover the y-direction side of the GNSS antenna element 60 as shown in FIG. 6 while ensuring a required area as an element of the bow-tie antenna, so that the portions 21a, 21b can be expected to play a role of suppressing the influence on the GNSS antenna.

The TEL antenna substrate 45 is held on the upper surface of the base 40 in substantially parallel to the xz plane and electrically connected to each of the portions corresponding to the apexes of the first plate-shaped metal 10 and the second plate-shaped metal 20, and each of the connecting points acts as a feeding point. The feeding point is located at a position offset in the +x direction from the x-direction center position of the first plate-shaped metal 10. Therefore, as shown in FIG. 6, the feeding point is shifted by a predetermined distance in the +x direction with respect to the imaginary line Lc parallel to the z direction passing through the middle point of the side of the first plate-shaped metal 10 facing the feeding point. Thus, in this embodiment, a larger distance is formed between the feeding point and the imaginary line Le parallel to the z direction passing through the −x-direction side end portion of the first plate-shaped metal 10, so that the magnetic cores 71 to 73 do not protrude from the imaginary line Le toward the −x direction. In other words, since the magnetic cores 71 to 73 are accommodated between the −x-direction side end portion of the first plate-shaped metal 10 and the feeding point in the x direction, the base 40 and the cover 80 constituting the case can be reduced in size so as to restrain an increase in product size while suppressing a leakage current. The TEL antenna substrate 45 is provided with a matching circuit.

The GNSS antenna substrate 50 is screwed and fixed to the upper surface of the base 40 in substantially parallel to the xy plane so as to sandwich the connecting portions 22 of the second plate-shaped metal 20. A substantially full GND pattern is disposed on the back surface (the surface on the −z-direction side) of the GNSS antenna substrate 50, and the GND pattern and the connecting portions 22 of the second plate-shaped metal 20 are electrically connected to each other. The GNSS antenna element 60 is mounted on the main surface (the surface on the +z-direction side) of the GNSS antenna substrate 50. A phase adjustment circuit, a coupled circuit, a bandpass filter, a low noise amplifier (LNA), a signal distribution circuit, etc. are disposed on the main surface of the GNSS antenna substrate 50. Feeding pins 61, 62 electrically connect electrodes (e.g., silver electrodes) on the surface of the GNSS antenna element 60 and the main surface of the GNSS antenna substrate 50 to each other. In the signal distribution circuit, for example, a Wilkinson distributor can be formed on the GNSS antenna substrate 50.

The feeder line 31 serving as the first coaxial cable has a center conductor electrically connected via the TEL antenna substrate 45 to the first plate-shaped metal 10 and an outer conductor electrically connected via the TEL antenna substrate 45 to the second plate-shaped metal 20. The tubular (e.g., cylindrical) magnetic core 71 for reducing a leakage current is mounted on the feeder line 31 (the feeder line 31 penetrates the magnetic core 71). The feeder lines 32, 33 serving as the second and third coaxial cables have center conductors electrically connected to signal lines (two respective signal lines distributed by the signal distribution circuit) of the GNSS antenna substrate 50, and outer conductors electrically connected to the GND pattern of the GNSS antenna substrate 50. The tubular (e.g., cylindrical) magnetic cores 72, 73 for reducing a leakage current are respectively mounted on the feeder lines 32, 33 (the feeder lines 32, 33 penetrate the respective magnetic cores 72, 73). The magnetic cores 71 to 73 are held at the x-direction positions equal to each other on the upper surface of the base 40 such that the axial direction is substantially parallel to the x direction. Terminals of the feeder lines 31 to 33 are attached to the connector 48. In this embodiment, the magnetic cores 71 to 73 have outer circumferential surfaces covered with respective sponge-like cushioning materials 81 to 83 so as to prevent direct contact with each other.

Although the present invention has been described hereinabove referring to the embodiments as examples, it is to be understood by those skilled in the art that the constituent elements and processing processes in the embodiments are variously modified without departing from the scope defined by the appended claims.

1. An antenna device comprising:
a bow-tie antenna;
a first coaxial cable connected to the bow-tie antenna; and
a first magnetic core penetrated by the first coaxial cable, wherein, when three respective orthogonal axes are an x axis, a y axis, and a z axis,
the bow-tie antenna includes a first plate-shaped metal plate having a portion extending from a feeding point in a positive z direction, substantially parallel to an xz plane, and a second plate-shaped metal plate having a portion extending from the feeding point in a negative z direction, substantially parallel to the xz plane,
the first magnetic core is located on a negative x-direction side of the feeding point and within a range where the first and second plate-shaped metal plates are present, in a z direction, and is positioned, in an x direction, overlapping the first and second plate-shaped metal plates, and
the feeding point is located at a position offset in a positive x direction, from an x-direction center position of the first plate-shaped metal plate or an x-direction center position of the second plate-shaped metal plate.

2. The antenna device according to claim 1, wherein the first magnetic core is accommodated between a negative x-direction side end portion of the first or second plate-shaped metal plate and the feeding point, in an x direction.

3. The antenna device according to claim 1, wherein the first magnetic core has an axial direction that is substantially parallel to the x direction.

4. An antenna device comprising:
a bow-tie antenna having a substantially triangular first plate-shaped metal plate, with an apex, and a substantially semicircular second plate-shaped metal plate with an apex;
a first coaxial cable connected to the bow-tie antenna; and
a first magnetic core penetrated by the first coaxial cable, wherein
the bow-tie antenna has a feeding point that is a mutual contact point between the first and second plate-shaped metal plates, and
distance from the feeding point to the apex of the first plate-shaped metal plate toward a side of the antenna device including the first magnetic core is longer than distance from the feeding point to the apex of the second plate-shape metal plate.

5. An antenna device comprising:
a bow-tie antenna;
a different antenna, different from the bow-tie antenna;
a first coaxial cable connected to the bow-tie antenna;
a second coaxial cable connected to the different antenna;
a first magnetic core penetrated by the first coaxial cable; and
a second magnetic core penetrated by the second coaxial cable, wherein, when three respective orthogonal axes are an x axis, a y axis, and a z axis,
the bow-tie antenna includes a first plate-shaped metal plate having a portion extending from a feeding point in a positive z direction, substantially parallel to an xz plane, and a second plate-shaped metal plate having a portion extending from the feeding point in a negative z direction, substantially parallel to the xz plane,
the second plate-shaped metal plate has a convex curved portion having a shorter dimension in a z-direction than the first plate-shaped metal plate and is curved to approach being parallel to the z direction as the convex curved portion extends in a negative x direction, from the feeding point, which is a contact point of the second plated-shaped metal plate with the first plate-shaped metal plate, and
one of the first and second magnetic cores is disposed toward a side of the antenna device including the second plate-shaped metal plate, in the z direction.

6. The antenna device according to claim 1, further comprising
a different antenna, different from the bow-tie antenna,
second and third coaxial cables connected to the different antenna, and
second and third magnetic cores respectively penetrated by the second ad third coaxial cables, wherein the first, second, and third magnetic cores are stacked in a trefoil formation.

7. The antenna device according to claim 6, wherein the first magnetic core has an axial direction that is substantially parallel to the x direction.

8. The antenna device according to claim 2, further comprising
a different antenna, different from the bow-tie antenna,
Second and third coaxial cables connected to the different antenna, and
second and third magnetic cores respectively penetrated by the second and third coaxial cables, wherein the first, second, and third magnetic cores are stacked in a trefoil formation.

9. The antenna device according to claim 3, further comprising
a different antenna, different from the bow-tie antenna,
Second and third coaxial cables connected to the different antenna, and
second and third magnetic cores respectively penetrated by the second and third coaxial cables, wherein the first, second, and third magnetic cores are stacked in a trefoil formation.

10. The antenna device according to claim 4, further comprising
a different antenna, different from the bow-tie antenna,
Second and third coaxial cables connected to the different antenna, and
second and third magnetic cores respectively penetrated by the second and third coaxial cables, wherein the first, second, and third magnetic cores are stacked in a trefoil formation.

11. The antenna device according to claim 5, further comprising
a third coaxial cable, wherein the second and third coaxial cables are connected to the different antenna, and
a third magnetic core, wherein
the second and third magnetic cores are respectively penetrated by the second and third coaxial cables, and
the first, second, and third magnetic cores are stacked in a trefoil formation.
